(19) United States
(12) Patent Application Publication
(10) Pub. No.: US 2023/0331164 A1
(43) Pub. Date: Oct. 19, 2023

(54) Accessory Carrier

(71) Applicant: APPLE INC., Cupertino, CA (US)

(72) Inventors: Moshe J. Baum, Merritt Island, FL (US); Kevin O. Miron, Sunnyvale, CA (US); Mikael P. Sedlacek, Carmel Valley, CA (US)

(21) Appl. No.: 18/177,829

(22) Filed: Mar. 3, 2023

Related U.S. Application Data
(60) Provisional application No. 63/331,522, filed on Apr. 15, 2022.

(51) Int. Cl. B60R 7/04

(52) U.S. Cl. CPC B60R 7/04

(57) ABSTRACT

A body defines an opening, an extendable support is movable between a retracted position and an extended position, and a is closure connected to the extendable support and movable between a closed position and a use position. An accessory support area is defined between the closure and the body when the closure is in the use position, and the accessory support area is configured to allow connection of an accessory.

### CROSS-REFERENCE TO RELATED APPLICATIONS

This application claims the benefit of U.S. Provisional Application No. 63/331,522, filed on Apr. 15, 2022, the contents of which are hereby incorporated by reference in their entirety for all purposes.

### FIELD

The present disclosure relates generally to the field of accessory carriers for vehicles.

### BACKGROUND

Vehicles are often used to carry cargo. Various types of cargo carrying arrangements have been used to carry specific types of cargo items or to increase cargo capacity.

### SUMMARY

One aspect of the disclosure is a vehicle that includes a vehicle body that defines an opening, an extendable support that is movable between a retracted position and an extended position, and a closure connected to the extendable support and movable between a closed position and a use position. The closure is located in the opening of the vehicle body when the closure is in the closed position, and the extendable support is in the retracted position when the closure is in the closed position. The closure is spaced from the opening of the vehicle body when the closure is in the use position, and the extendable support is in the extended position when the closure is in the use position. An accessory support area is defined between the closure and the vehicle body when the closure is in the use position, and the accessory support area is configured to allow connection of an accessory to the vehicle.

The vehicle may include a seal that is connected to the vehicle body and extends around the opening, wherein the seal is engaged with the closure when the closure is in the closed position, and the seal is engaged with the accessory when the closure is in the use position and the accessory is connected to the vehicle. The vehicle may include releasable couplers that are configured to connect the accessory to at least one of the extendable support, the closure, or the vehicle body.

In some implementations, the accessory is located in an interior space of the vehicle body when the closure is in the closed position and the accessory is slidable at least partially out of the interior space of the vehicle body through the opening of the vehicle body when the closure is in the use position. The vehicle may include a seal connected to the vehicle body and extending around the opening, wherein the seal is engageable with a peripheral surface of the accessory. The vehicle may include a deployable ramp that is connected to the extendable support and movable between a stowed position and a deployed position.

The vehicle may include a pivot joint that connects the closure to the extendable support and is configured to allow the closure to pivot with respect to the extendable support between a generally upright orientation and a generally horizontal orientation. The closure may be in the generally upright orientation in the closed position and the closure may be in the generally upright orientation in the use position. In some implementations, the closure is movable to an open position, the extendable support is in the retracted position when the closure is in the open position, and the closure is in the generally horizontal orientation in the open position. In some implementations the closure is movable to a loading position, the extendable support is in the extended position when the closure is in the loading position, and the closure is in the generally horizontal orientation in the loading position.

The vehicle may include a sensor that is located on the closure and is configured to move with the closure. The sensor may be a camera.

Another aspect of the disclosure is a vehicle that includes a vehicle body that defines an opening and a surface extending around the opening. A seal is located on the surface and extends around the opening. An accessory carrier has an extendable support and a closure, wherein the accessory carrier is movable between a closed position and a use position by extension and retraction of the extendable support, and the closure is engaged with the seal in the closed position. An accessory is connectable to the accessory carrier, wherein the accessory is in engagement with the seal when the accessory is connected to the accessory carrier.

In some implementations, engagement of the seal with the accessory seals an internal space of the vehicle against entry of water when the accessory is connected to the accessory carrier. A longitudinal end wall of the accessory may be oriented toward the opening and be in engagement with the seal when the accessory is connected to the accessory carrier. The longitudinal end wall of the accessory may be free from openings so that an interior space of the accessory is not accessible from an interior space of the vehicle body when the accessory is connected to the accessory carrier.

Another aspect of the disclosure is a vehicle that includes a vehicle body that defines an opening, an extendable support movable between a retracted position and an extended position, and a closure having an outer closure panel that is connected to the extendable support and an inner closure panel that is pivotally connected to the vehicle body. The outer closure panel is movable between a closed position of the outer closure panel, in which the outer closure panel is adjacent to the inner closure panel and the extendable support is in the retracted position, and a use position of the outer closure panel, in which the outer closure panel is spaced from the inner closure panel and the extendable support is in the extended position to define an accessory support area. The inner closure panel is movable between a closed position of the inner closure panel, in which the inner closure panel is located in the opening, and an open position of the inner closure panel, in which the inner closure panel is spaced from the opening.

The vehicle may include a pivot joint that connects the outer closure panel to the extendable support and is configured to allow the outer closure panel to pivot with respect to the extendable support between a generally upright orientation and a generally horizontal orientation, wherein the outer closure panel is in the generally upright orientation in the closed position and the outer closure panel is in the generally upright orientation in the use position. In some implementations, the outer closure panel is movable to an open position, the extendable support is in the retracted position in the open position of the outer closure panel, the outer closure panel is in the generally horizontal orientation in the open position of the outer closure panel, the outer closure panel is movable to a loading position, the extendable support is in the extended position in the loading position of the outer closure panel, and the outer closure panel is in the generally horizontal orientation in the loading position of the outer closure panel. The vehicle may include releasable couplers that are configured to connect an accessory to at least one of the extendable support, the outer closure panel, the inner closure panel, or the vehicle body in order to secure the accessory.

### BRIEF DESCRIPTION OF THE DRAWINGS

FIGS. 1A-1D is a perspective illustration of a vehicle having an accessory carrier.

FIG. 2 is an illustration of a support beam of the accessory carrier.

FIG. 3 a side view illustration of the vehicle showing the accessory carrier and an accessory according to a first example.

FIG. 4 a side view illustration of the vehicle showing the accessory carrier and an accessory according to a second example.

FIG. 5 a side view illustration of the vehicle showing the accessory carrier and an accessory according to a third example.

FIG. 6 a side view illustration of the vehicle showing the accessory carrier and an accessory according to a fourth example.

FIGS. 7A-7B show an accessory carrier according to an alternative implementation.

FIGS. 8A-8C show an accessory carrier that includes a deployable ramp.

FIGS. 9A-9C show an accessory carrier that includes a deployable ramp.

FIGS. 10A-10E show an accessory carrier that includes a movable cargo tray.

FIG. 11 is a block diagram of the vehicle.

FIG. 12 is a block diagram of a control system according to an example.

### DETAILED DESCRIPTION

The disclosure herein relates to a vehicle having an accessory carrier that is defined in part by a closure (e.g., a panel that can be opened and closed). The accessory carrier is movable from a closed position to a use position, in which cargo items or accessories can be secured to the accessory carrier. In some implementations, the accessory that is carried by the accessory carrier may engage a seal that extends around an opening that is defined by the vehicle body, in order to seal the opening against entry of water and wind while the accessory is being carried by the accessory carrier.

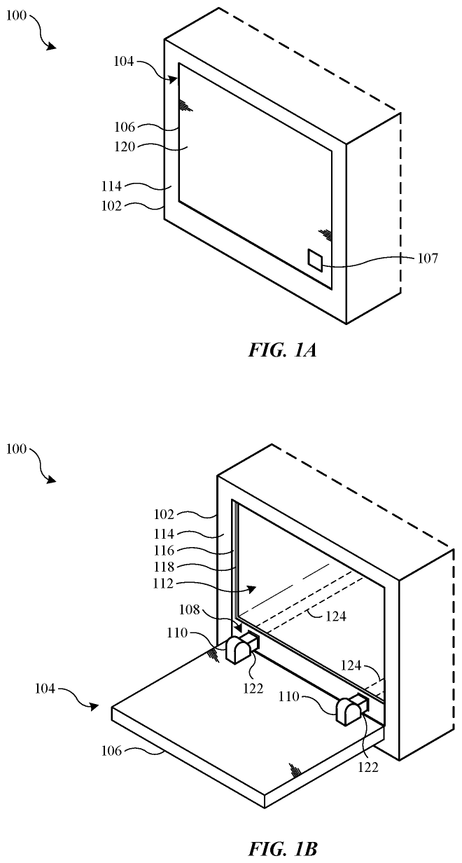

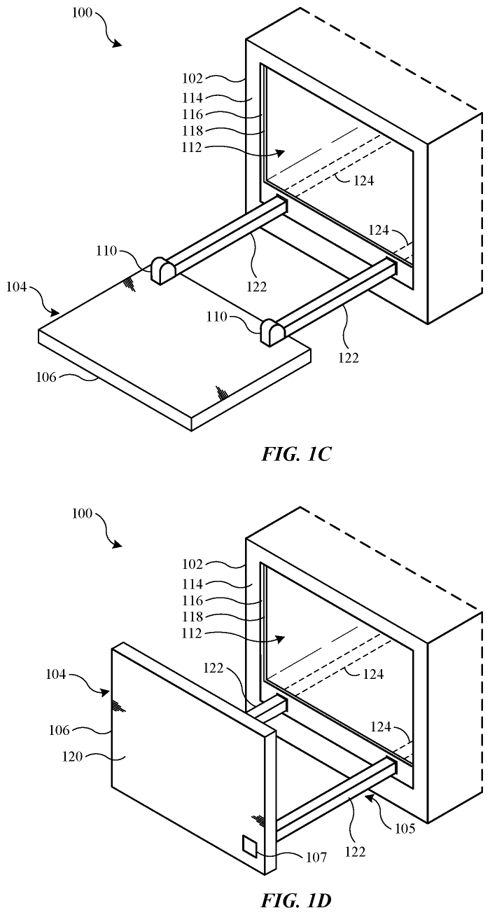

FIGS. 1A-1D are a perspective illustrations of a vehicle 100 that includes a vehicle body 102 and an accessory carrier 104. The accessory carrier 104 includes a closure 106, an extendable support 108, and pivot joints 110. The closure 106 (e.g., a closure panel or a movable panel) is an openable panel that is configured to provide access to an interior space that is defined by the vehicle body 102, such as a cargo area. The closure 106 is connected to the vehicle body 102 by the extendable support 108 and the pivot joints 110. The closure 106 of the accessory carrier 104 is movable between a closed position (FIG. 1A), an open position (FIG. 1B), a loading position (FIG. 1C), and a use position (FIG. 1D). These positions may also be referred to as positions of the accessory carrier 104.

The vehicle 100 may be a road going vehicle that includes features that are typically found in conventional examples of such vehicles. As an example, the vehicle body 102 may be part of a sprung mass of the vehicle 100 that is supported with respect to a surface (e.g., a road surface) by wheels, tires, suspension components, and other conventional components. These and other conventional vehicle components are not shown herein for clarity.

The vehicle body 102 includes multiple structures that in combination define the primary structural and aesthetic components of the vehicle 100, such as the body, chassis, and/or frame of the vehicle 100. The vehicle body 102 may be or include exterior body panels, interior panels, trim components, a frame, a subframe, a unibody, a monocoque, and/or other vehicle body components of any type. The vehicle body 102 defines one or more interior spaces (not shown), such as a passenger compartment and/or a cargo compartment.

The vehicle body 102 and other components of the vehicle 100 may be referred to herein as extending a longitudinal direction, a lateral direction, and in an elevational direction. The longitudinal direction is a front-to-rear direction that corresponds to straight-line travel of the vehicle 100. The lateral direction is a side-to-side direction of the vehicle 100. The elevational direction is top-to-bottom direction of the vehicle 100.

The vehicle body 102 defines an opening 112 that allows an interior space 113 (e.g., cargo compartment) that is defined by the vehicle body 102 to be accessed from outside the vehicle 100. As an example, the opening 112 may extend through a wall panel 114 that is defined by the vehicle body 102. The wall panel 114 may be defined continuously around the opening 112 (e.g., adjacent to top, bottom, left, and right sides thereof). A surface 116 extends around the opening 112 (e.g., around the periphery of the opening 112). A seal 118 is connected to the vehicle body 102 and is located on the surface 116. As an example, the seal 118 may extend continuously around the opening 112 on the surface 116. The seal 118 is intended to define a sealed interface between the closure 106 and the vehicle body 102 when the accessory carrier 104 is in the closed position (FIG. 1A), by engagement of the seal 118 with the surface 116 and the closure 106. The seal 118 is a flexible, resilient structure of conventional design, which may be formed from, for example, synthetic rubber.

The structural configuration of the closure 106 is equivalent to that of a door or a liftgate of a conventional vehicle, except as described otherwise herein. Example, the closure 106 may define part of a side, front, or back of the vehicle body 102 of the vehicle 100, and may include a window.

The vehicle 100 may include one or more sensors 107 that are located on the closure 106. Examples of devices that may be included in the sensors 107 include cameras, LIDAR devices, and other two-dimensional and three-dimensional imaging devices. The sensors 107 may be used by the vehicle 100 as inputs to automated driving functions. Because they are located on the closure 106, the one or more sensors 107 are configured to move with the closure 106, for example, during movement between the closed position and the use position. By placing the sensors 107 on the closure 106, the field of view of the each of the sensors 107 will not be obstructed by objects placed on the accessory carrier 104, as could occur with respect to sensors that are located on the vehicle body 102.

In the closed position (FIG. 1A), the closure 106 occupies the opening 112 in the vehicle body 102, such that the interior space 113 of the vehicle body 102 cannot be accessed through the opening 112. The closure 106 has an exterior surface 120 that is generally aligned with the surface of the wall panel 114 of the vehicle body 102 when the closure 106 is in the closed position. In the open position (FIG. 1B), the closure 106 is moved out of the opening 112, and no longer obstructs the opening 112, thereby allowing access to the interior of the vehicle body 102 through the opening 112. Illustrated implementation, the closure 106 moves from the closed position to the open position by pivoting downward using the pivot joints 110. Thus, in the closed position, the closure 106 may be positioned so that it is generally upright, and in the open position, the closure 106 may be positioned so that it is generally horizontal.

To move the closure 106 between the closed position and the open position, the pivot joints 110 may be controllable electromechanical devices (e.g., incorporating an electric motor that drives pivoting movement of the closure) that are connected to the closure 106 and to the extendable support 108. In the closed position, the pivot joints 110 may be positioned at their closest location relative to the vehicle body 102, thereby placing and axis of rotation of the closure 106 adjacent to the vehicle body 102 during movement between the closed position and the open position.

The accessory carrier 104 may be moved from the open position to a loading position (FIG. 1C) and to a use position (FIG. 1D). In the loading position, the closure 106 is positioned in a generally horizontal orientation (e.g., within thirty degrees of horizontal), and is spaced from the vehicle body 102 in the longitudinal direction by the extendable support 108. In the use position, the closure 106 is positioned in a generally upright orientation (e.g., within thirty degrees of vertical), and is spaced from the vehicle body 102 in the longitudinal direction by the extendable support 108. The space between the closure 106 and the vehicle body 102 defines an accessory support area 105, for example, on the extendable support 108. In the loading position, the generally horizontal orientation of the closure 106 facilitates loading and unloading of cargo items with respect to the accessory carrier 104. In the use position, the generally upright orientation of the closure 106 allows for securement of cargo items between the closure 106 and the vehicle body 102, for example, by securing the cargo items to the closure 106, the extendable support 108, and/or the vehicle body 102.

During movement from the open position to a loading position and to a use position, the closure 106 moves in the longitudinal direction relative to the vehicle body 102. The closure 106 is closest to the vehicle body 102 in the closed position, and is relatively farther from the vehicle body 102 in the loading position and the use position.

To move the accessory carrier 104 between the open position and the loading position or the use position, the extendable support 108 is movable between a retracted position (FIGS. 1A-1B) and an extended position (FIGS. 1C-1D). The extendable support 108 is located near a bottom end of the opening 112 and is connected to the bottom end of the closure 106 by the pivot joints. This vertical position allows the extendable support 108 to define a cargo area between the closure 106 and the vehicle body 102, and cargo items and/or accessories can be secured to the accessory carrier 104 in the cargo area when the accessory carrier 104 is in the use position.

In the illustrated implementation, the extendable support 108 includes support beams 122 that are located primarily within the vehicle body 102 in the retracted position, such as in housings 124 that are defined by the vehicle body 102 and located, for example, under a floor of the cargo area of the vehicle 100. During movement from the retracted position toward the extended position, the support beams 122 move outward relative to the housings 124 so that a greater length of the support beams extends out of the housings 124 in order to space the closure 106 from the vehicle body 102. In the extended position, a majority of the length of the support beams 122 may be located outside of the housings 124 and located rearward from the surface 116 of the vehicle body 102 and the opening 112 of the vehicle body 102.

The support beams 122 of the illustrated implementation include two separate beams that are spaced apart from one another in the lateral direction of the vehicle 100. Other configurations may be used for the support beams 122. In addition, other types of structures may be used as the extendable support 108 instead of the support beams 122, such as an extendable panel that extends continuously in the lateral direction and has a width that is, for example, 75% or more of a width of the closure 106.

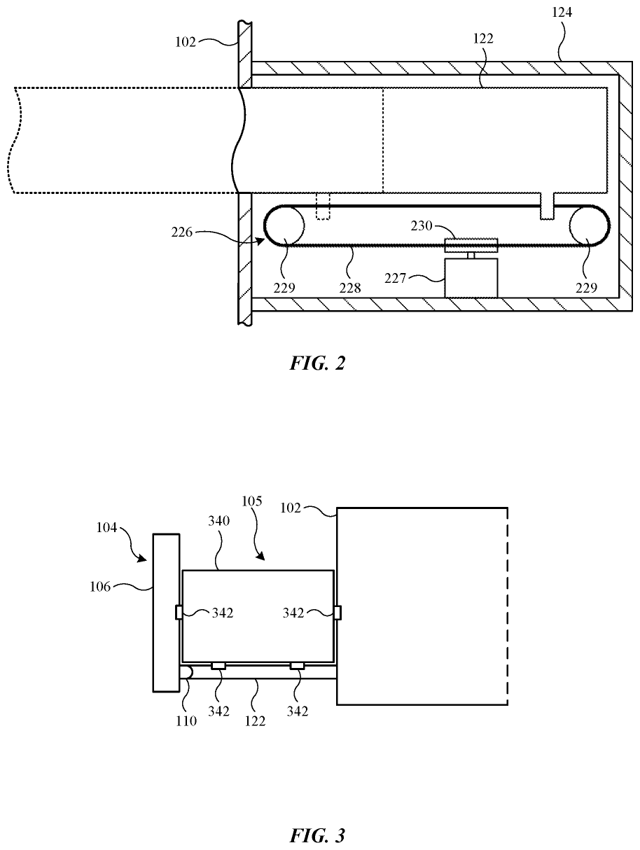

An example implementation of the support beams 122 is shown in FIG. 2 (in which a single one of the support beams is shown). In the retracted position, the support beams 122 are located primarily in the housings 124, and is connected to and actuator system 226 it is configured to move the support beams 122 between the retracted position and the extended position (shown in dashed lines). The actuator system 226 includes an electric motor 227 that is connected to the support beams 122 by a cable 228. The cable 228 is coupled to a spool 230 that is driven by the electric motor 227, and is supported in part by pulleys 229 that define a loop configuration for the cable 228, and allow the cable 228 to thereby drive extension and retraction of the support beams 122 through one or more connections of the cable 228 to the support beams 122. Other configurations and types of actuators can be employed in the actuator system 226 to cause movement of the extendable support 108 between the retracted position and the extended position. In addition, although the support beams 122 are shown as single-piece beams in the illustrated implementation, the support beams 122 may instead be multi-piece beams that extend and retract telescopically, and the actuator system 226 can be adapted to drive telescopic extension and retraction of the support beams 122 according to known designs.

The accessory carrier 104 can be moved from the loading position to the use position by pivoting the closure 106 upwards from the generally horizontal position to the generally upright position using the pivot joints 110. Movement of the accessory carrier 104 from the use position to the loading position occurs in the opposite manner. The accessory carrier 104 can be moved directly from the closed position to the use position without first moving to the open position or the loading position, for example, by moving the extendable support 108 from the retracted position to the extended position without first pivoting the closure 106 downward, and the accessory carrier 104 can be moved directly from the use position to the closed position in the opposite manner.

Thus, the vehicle 100 includes the vehicle body 102, which that defines the opening 112, the extendable support 108, and the closure 106. The vehicle body 102 may extend continuously around the opening 112 (e.g., defining top, bottom, left, and right portions that frame the opening). The extendable support 108 is movable between the retracted position and the extended position. The closure 106 is connected to the extendable support 108 and is movable between the closed position and the use position. The closure 106 is located in the opening 112 of the vehicle body 102 and may obstruct the opening 112 of the vehicle body 102 when the closure 106 is in the closed position, and the extendable support 108 is in the retracted position when the closure 106 is in the closed position. The closure 106 is spaced from the opening 112 of the vehicle body 102 when the closure is in the use position, and the extendable support 108 is in the extended position when the closure 106 is in the use position. The accessory support area 105 is defined between the closure 106 and the vehicle body 102 when the closure 106 is in the use position, and the accessory support area 105 is configured to allow connection of an accessory to the vehicle 100.

FIG. 3 a side view of the vehicle 100 that shows the accessory carrier 104 in the use position and an accessory 340 according to a first example. The accessory 340 is connected to the accessory carrier 104. The accessory 340 is connectable and disconnectable with respect to the accessory carrier 104, for example, using releasable couplers 342, which are any manner of releasable coupling device capable of being moved between a connected position and a disconnected position to allow the accessory 340 be securely connected to the accessory carrier 104 and subsequently removed when not needed. As examples, the releasable couplers 342 maybe releasable locking pins, clamps, bolts, or other types of releasable mechanical fasteners. In some implementations, the releasable couplers 342 may be controllable electromechanical devices, for example, incorporating electric motors, solenoids, or other controllable electronic components that allow the releasable couplers 342 to be moved between secured and released positions by a signal from a control system. The releasable couplers 342 may be located on the closure 106, the extendable support 108, or the vehicle body 102, and may be engageable with corresponding features that are formed on the accessory 340.

The accessory 340 is intended to supplement the capabilities of the vehicle 100 and the accessory carrier 104, such as by adapting the accessory carrier 104 to carry a specific type of cargo, or by adding a particular type of functionality to the vehicle 100. As one example, the accessory 340 may be a bike rack, as another example, the accessory 340 may be cargo storage container. As another example, the accessory 340 may be a battery pack that is intended to supply electrical power to an electric propulsion system of the vehicle 100 in order to supplement the power supplied by an inboard battery pack of the vehicle 100 to provide extended range for the vehicle 100. As another example, the accessory 340 may be a refrigerated storage compartment. As another example, the accessory 340 may be a food preparation station including a grill, a stove, and/or other accessories used for cooking. the foregoing are examples, and the accessory 340 may be configured to perform functions that are not explicitly stated here.

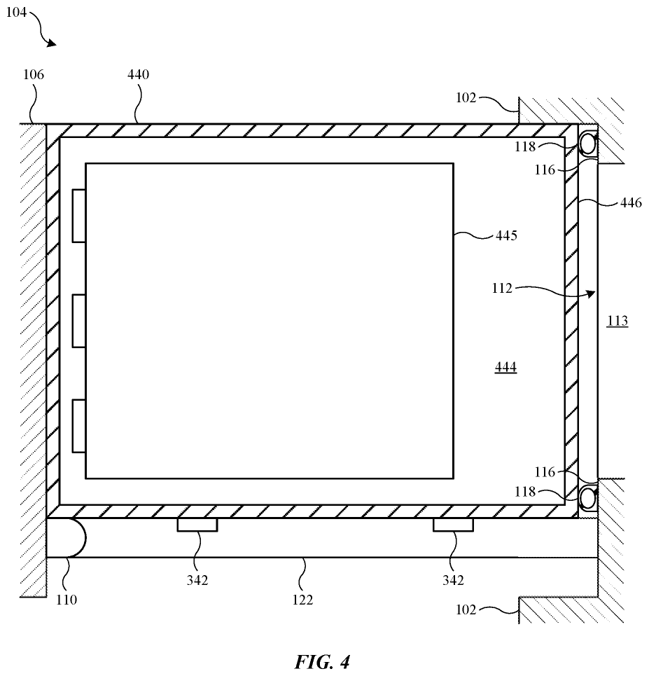

FIG. 4 is a side cross section view of the vehicle 100 that shows the accessory carrier 104 in the use position and an accessory 440 according to a second example. The accessory 440 is connected to the accessory carrier 104 and is connectable and disconnectable with respect to the accessory carrier 104, for example, using the releasable couplers 342 as previously described. In the illustrated implementation, the accessory 440 is a cargo storage container that defines an interior space 444 that is configured to carry cargo items. The accessory 440 includes a door 445 that may be opened and closed to allow the interior space 444 to be accessed from outside of the vehicle 100. The accessory 440 includes a longitudinal end wall 446 that is oriented toward the opening 112 of the vehicle body 102 when the accessory 440 is connected to the accessory carrier 104.

When the accessory carrier 104 is in the use position, the closure 106 of the accessory carrier 104 is not an engagement with the seal 118. To resist entry of water into the interior space 113 of the vehicle body 102 when the accessory carrier 104 is in the use position, the accessory 440 is configured to engage the seal 118. In particular, the seal 118 may be compressed between the surface 116 of the vehicle body 102 and the longitudinal end wall 446 of the accessory 440. As previously described, the seal 118 may extend continuously around the opening 112 on the surface 116. To allow engagement of the longitudinal end wall 446 of the accessory 440 with the seal 118, the longitudinal end wall 446 may be sized so that it has an area that is larger than the area that is circumscribed by the seal 118, so that an entirety of the seal 118 is contacted by the longitudinal end wall 446 of the accessory 440 and thereby compressed between the surface 116 of the vehicle body 102 and the longitudinal end wall 446. Thus, by compressing the seal 118 between the surface 116 and the longitudinal end wall 446 of the accessory 440, entry of water into the interior space 113 of the vehicle body 102 is resisted. In addition, compression of the seal 118 between the surface 116 and the longitudinal end wall 446 may also reduce wind noise that may otherwise be present.

In one implementation, connection of the accessory 440 to the accessory carrier 104 by the releasable couplers 342 serves to compress the seal 118 between the surface 116 and the longitudinal end wall 446, according to the position of the releasable couplers 342 with respect to the vehicle body 102. In another implementation, movement of the closure 106 from a generally horizontal orientation in the loading position to a generally upright orientation in the use position causes the closure 106 to come into contact with the accessory 440, and engagement of the closure 106 with the accessory 440 applies a force to the accessory 440 that urges it into engagement with the seal 118 to compress the seal 118 between the surface 116 and the longitudinal end wall 446.

Thus, the vehicle 100 may include the vehicle body 102, which defines the opening 112 and defines the surface 116, which extends around the opening 112. The seal 118 is located on the surface 116 and extends around the opening 112. The accessory carrier 104 includes the extendable support 108 and the closure 106. The accessory carrier 104 is movable between a closed position and a use position by extension and retraction of the extendable support 108. The closure 106 is engaged with the seal 118 in the closed position. The accessory 440 is connectable to the accessory carrier 104, and the accessory 440 is in engagement with the seal 118 when the accessory 440 is connected to the accessory carrier 104. Engagement of the seal 118 with the accessory 440 may seal the interior space 113 of the vehicle 100 against entry of water when the accessory 440 is connected to the accessory carrier 104. The longitudinal end wall 446 of the accessory 440 may be oriented toward the opening 112 and be in engagement with the seal 118 when the accessory 440 is connected to the accessory carrier 104. The longitudinal end wall 446 of the accessory 440 may be free from openings so that the interior space 444 of the accessory 440 is not accessible from the interior space 113 of the vehicle body 102 when the accessory 440 is connected to the accessory carrier 104.

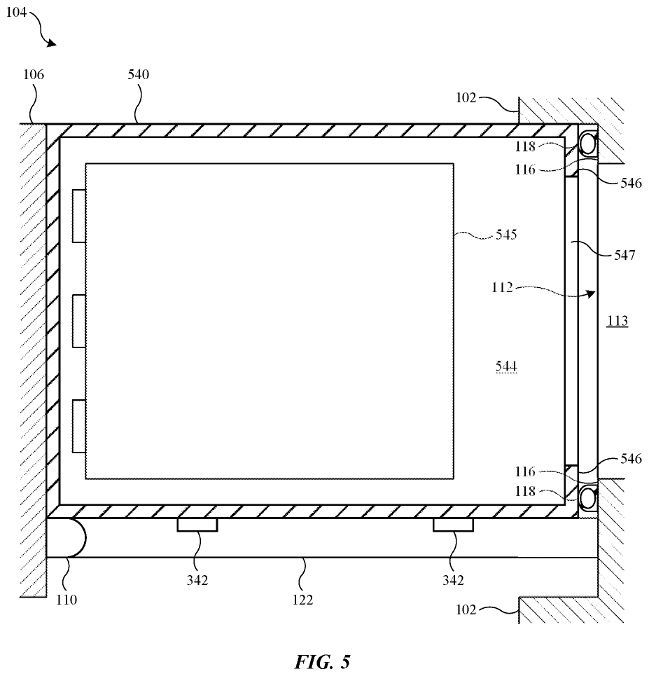

FIG. 5 is a side cross section view of the vehicle 100 that shows the accessory carrier 104 in the use position and an accessory 540 according to a third example. The accessory 540 is connected to the accessory carrier 104 and is connectable and disconnectable with respect to the accessory carrier 104, for example, using the releasable couplers 342 as previously described. In the illustrated implementation, the accessory 540 is a cargo storage container that defines an interior space 544 that is configured to carry cargo items. The accessory 540 includes a door 545 that may be opened and closed to allow the interior space 544 to be accessed from outside of the vehicle 100. The accessory 540 includes a longitudinal end wall 546 that is oriented toward the opening 112 of the vehicle body 102 when the accessory 540 is connected to the accessory carrier 104, so that the seal 118 may be compressed between the longitudinal end wall 546 of the accessory 540 as described with respect to the accessory 440.

The accessory 540 differs from the accessory 440 in that an opening 547 is formed through the longitudinal end wall 546. The outer periphery of the opening 547 is located inward on the longitudinal end wall 546 of the accessory 540 relative to the area of the longitudinal end wall 546 that engages the seal 118 when the accessory 540 is connected to the accessory carrier 104. By forming the opening 547 through the longitudinal end wall 546 of the accessory 540, the interior space 544 of the accessory 540 can be accessed from the interior space 113 of the vehicle body 102 when the accessory 540 is connected to the accessory carrier 104.

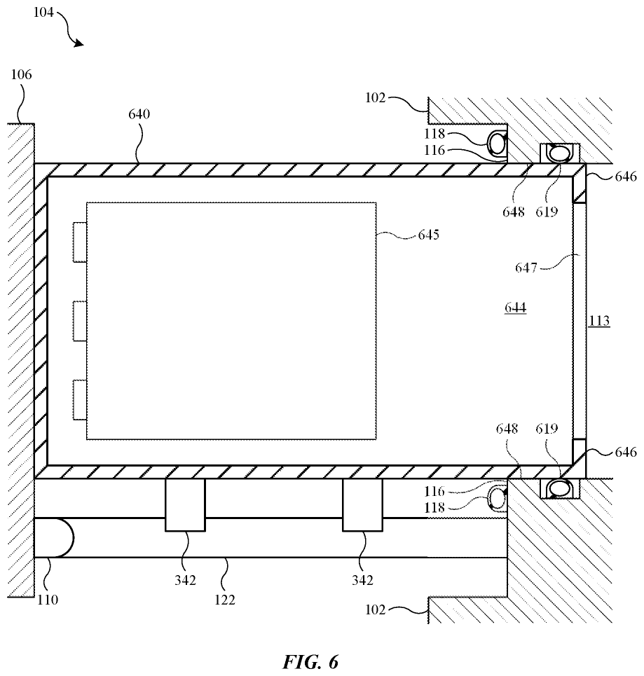

FIG. 6 is a side cross section view of the vehicle 100 that shows the accessory carrier 104 in the use position and an accessory 640 according to a fourth example. The accessory 640 is connected to the accessory carrier 104 and is connectable and disconnectable with respect to the accessory carrier 104, for example, using the releasable couplers 342 as previously described. In the illustrated implementation, the accessory 640 is a cargo storage container that defines an interior space 644 that is configured to carry cargo items. The accessory 640 includes a door 645 that may be opened and closed to allow the interior space 644 to be accessed from outside of the vehicle 100. The accessory 640 may include an opening 647 that is formed through the longitudinal end wall 646 to allow access to the interior space 644 of the accessory 640 from the interior space 113 of the vehicle body 102 when the accessory 640 is connected to the accessory carrier 104.

The accessory 640 differs from the accessory 440 in that it sized to extend into the interior space 113 of the vehicle body 102, and may be moved into and out of the interior space 113 of the vehicle body 102 through the opening 112 thereof in a telescopic manner. As an example, the accessory 640 may be located entirely inside the interior space 113 when the accessory carrier 104 is in the closed position, and may be moved outward from the interior space 113 when the accessory carrier 104 is in the open position, the loading position, and/or the use position. In the use position, the accessory 640 may remain positioned partly in the interior space 113 while extending out of the opening 112 and further extending from the vehicle body 102 to the closure 106.

Instead of engaging the seal 118, which faces longitudinally rearward, the accessory 640 is configured to engage a seal 619 that is connected to the vehicle body 102, encircles the opening 112, and faces inward toward the opening 112. The seal 619 is similar in structure to the seal 118 but is oriented so that it can be compressed in an outward direction (e.g., including in the lateral direction and the elevational direction) relative to the opening 112. This configuration allows the seal 619 to engage peripheral walls 648 of the accessory 640, such as an upper wall, a lower wall, a left wall, and a right wall.

Thus, the accessory 640 may be located in the interior space 113 of the vehicle body 102 when the closure 106 is in the closed position and the accessory 640 may be slidable at least partially out of the interior space 113 of the vehicle body 102 through the opening 112 of the vehicle body 102 when the closure 106 is in the use position. The vehicle 100 may the seal 619, which is connected to the vehicle body 102 and extends around the opening 112, wherein the seal 619 is engageable with a peripheral surface (e.g., including top and side surfaces) of the accessory 640.

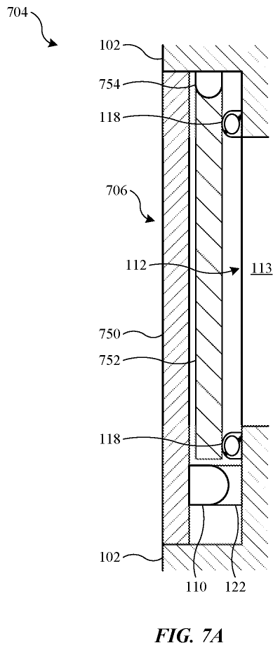

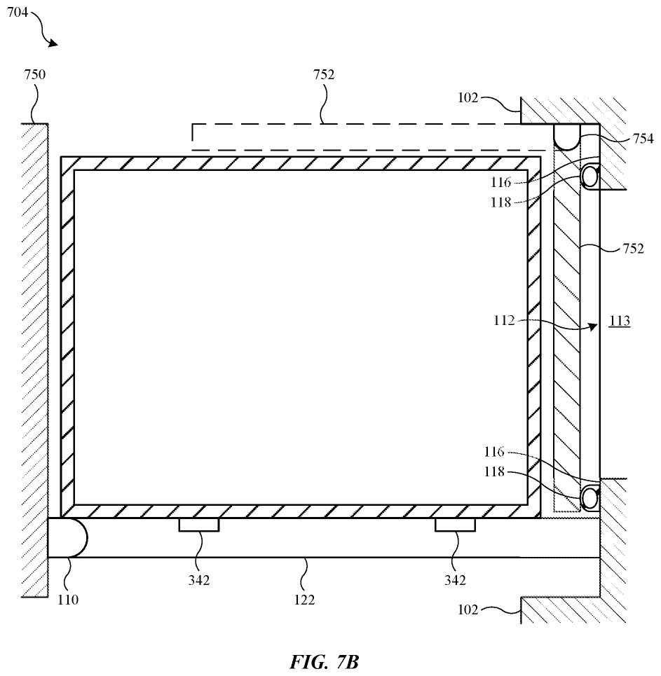

FIGS. 7A-7B show an alternative implementation in which the vehicle 100 includes an accessory carrier 704. The vehicle 100 and the accessory carrier 704 are consistent with the previous description except as otherwise stated, and like-numbered components may be implemented in the manner previously described. A closed position of the accessory carrier 704 is shown in FIG. 7A, and a use position of accessory carrier 704 is shown in FIG. 7B. The open position and the loading position of the accessory carrier 704 are similar to the like-named positions described with respect to the accessory carrier 104.

Relative to the accessory carrier 104, the closure 106 is omitted in lieu of a closure 706 having an outer closure panel 750 and an inner closure panel 752. The outer closure panel 750 is configured in the manner described with respect to the closure 106, and it is supported by the extendable support 108 as previously described, so that the outer closure panel 750 moves according to extension and retraction of the extendable support 108 and is pivotable by operation of the pivot joints 110. The outer closure panel 750 does not, however, contact the seal 118 in the closed position to seal the interior space 113 of the vehicle body 102 with respect to the exterior of the vehicle 100 as described with respect to the closure 106. This function is performed by the inner closure panel 752, which is located between the outer closure panel 750 and the interior space 113 of the vehicle body 102 when the accessory carrier 704 is in the closed position. When the accessory carrier 704 is in the open position, the loading position, and the use position, the outer closure panel 750 is spaced from the inner closure panel 752, which remains in place in a closed position, and the inner closure panel 752 is movable between the closed position (shown in solid lines) and an open position (shown in dashed lines).

The inner closure panel 752 is connected to the vehicle body 102 by a pivot joint 754, which is a controllable electromechanical device, for example, including an electric motor that is actuatable to cause movement of the inner closure panel 752 between the closed position and the open position. In the closed position, the inner closure panel 752 is in contact with the seal 118 in order to seal the interior space 113 of the vehicle body 102 with respect to the outside of the vehicle 100. In the open position, the inner closure panel 752 is spaced from the seal 118 and is spaced from the opening 112 vehicle body 102 in order to allow access to the interior space 113 of the vehicle body 102.

Thus, the closure 706 may include the outer closure panel 750, which is connected to the extendable support 108, and the inner closure panel 752, which is pivotally connected to the vehicle body 102 by the pivot joint 754. The outer closure panel 750 may be movable between the closed position of the outer closure panel 750, in which the outer closure panel 750 is adjacent to the inner closure panel 752 and the extendable support 108 is in the retracted position, and a use position of the outer closure panel 750, in which the outer closure panel 750 is spaced from the inner closure panel 752 and the extendable support 108 is in the extended position to define the accessory support area 105. The inner closure panel 752 is movable between the closed position of the inner closure panel 752, in which the inner closure panel 752 is located in the opening 112, and an open position of the inner closure panel 752, in which the inner closure panel 752 is spaced from the opening 112. In this implementation, the releasable couplers 342 may be configured to connect an accessory any or all of the extendable support 108, the outer closure panel 750, the inner closure panel 752, or the vehicle body 102 in order to secure an accessory, such as the accessory 340.

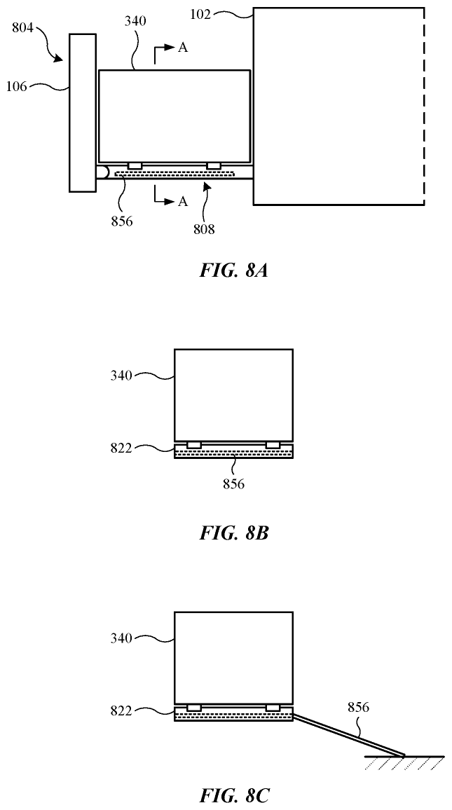

FIGS. 8A-8C show an alternative example that includes an accessory carrier 804 that includes a deployable ramp 856. FIG. 8A is a side view showing the deployable ramp 856 in a stowed position, FIG. 8B is a rear view along line A of FIG. 8A showing the deployable ramp 856 in the stowed position, and FIG. 8C is a rear view along line A of FIG. 8A showing the deployable ramp 856 in a deployed position.

The accessory carrier 804 is equivalent to the accessory carrier 704 except as stated herein, and can be implemented in the manner previously described. The accessory carrier includes 804 includes an extendable support 808 that is similar to the extendable support 108 but is in the form of a panel that extends in the lateral direction, e.g., across 75% or more of a width of a closure 806, which is equivalent to the closure 106. The deployable ramp 856 is located within the lateral extents of the extendable support 808 in the stowed position, and is movable to the deployed position, in which the deployable ramp 856 extends outward and downward from the extendable support 808. The deployable ramp 856 may extend downward to an underlying surface (e.g., the ground) when it is in the deployed position. This facilitates loading and unloading of cargo items and accessories on the accessory carrier 704. The deployable ramp 856 may move between positions manually, for example, on sliding joints or rollers, or the deployable ramp 856 may incorporate an actuator system that is configured to move the deployable ramp 856 automatically between the stowed position and the deployed position.

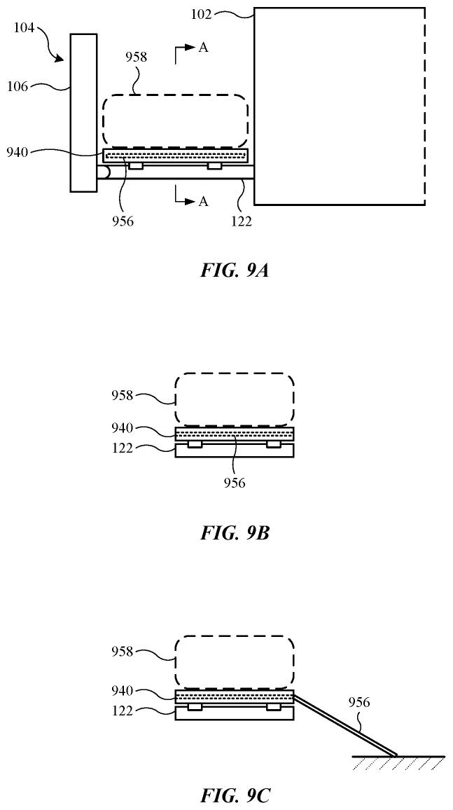

FIGS. 9A-9C show an alternative example in which an accessory 940 is connected to the accessory carrier 104 and includes a deployable ramp 956. FIG. 9A is a side view showing the deployable ramp 956 in a stowed position, FIG. 9B is a rear view along line B of FIG. 9A showing the deployable ramp 956 in the stowed position, and FIG. 9C is a rear view along line A of FIG. 9A showing the deployable ramp 956 in a deployed position. The deployable ramp 956 is located in the accessory 940, but is otherwise configured in the manner described with respect to the deployable ramp 856, and facilitates loading and unloading of a cargo item 958 on the accessory 940. As an example, the accessory 940 may be a bike rack, and the deployable ramp 956 can facilitate loading and unloading of bicycles on the bike rack.

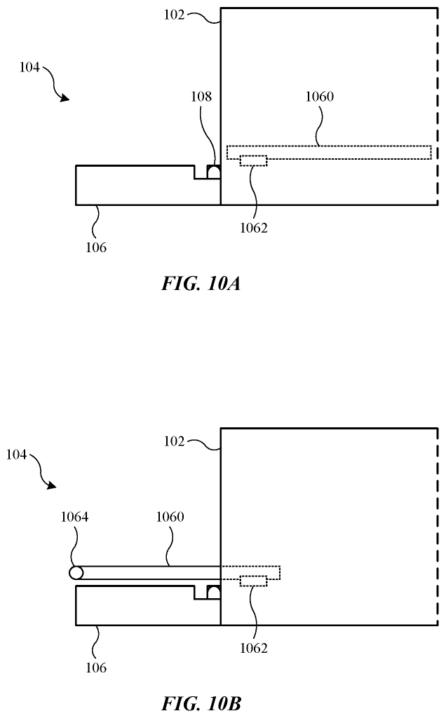

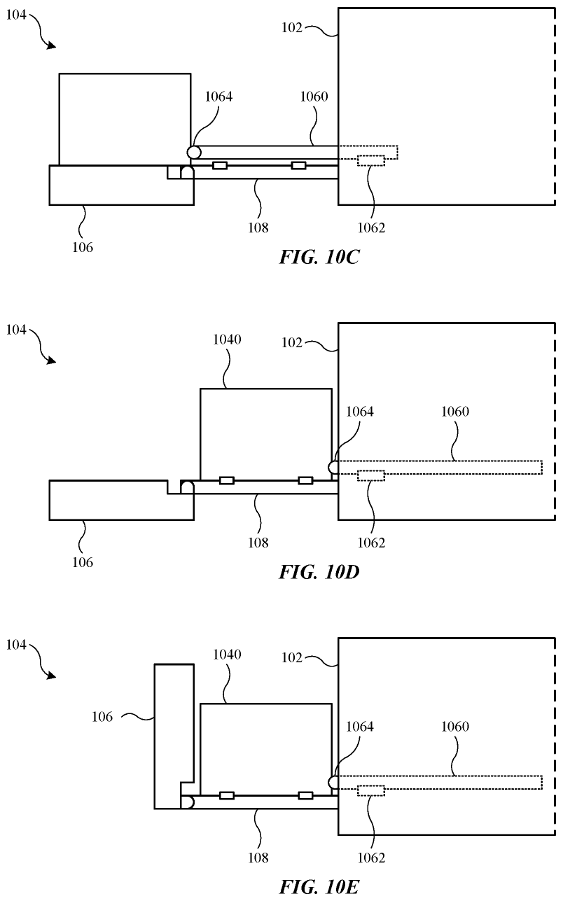

FIGS. 10A-10E show an alternative example in which the accessory carrier 104 includes a deployable cargo tray 1060 that is movable between a retracted position and an extended position by an actuator system 1062. The actuator system 1062 is controllable (e.g., by commands received from a controller), and may be implemented using conventional components (e.g., sliding mounts, electric motors, cables, etc.) such that the actuator system 1062 is configured to move the deployable cargo tray between the retracted and extended positions.

FIG. 10A is a side view showing the closure 106 accessory carrier 104 in the open position, and showing the deployable cargo tray 1060 in the retracted position. FIG. 10B Is a side view showing the closure 106 of the accessory carrier 104 in the open position and the deployable cargo tray 1060 in the extended position. FIG. 10C and FIG. 10D are side views showing the closure 106 of the accessory carrier 104 in the loading position. In FIG. 10C, the deployable cargo tray 1060 is in the extended position and is connected to an accessory 1040, which is positioned on the closure 106. In particular, the deployable cargo tray 1060 is connected to the accessory 1040 by a coupler 1064 that can be controlled to engage and release the connection of the deployable cargo tray 1060 to the accessory 1040. The coupler 1064 may be implemented using conventional components (e.g., actuated clamps, hooks, electromagnets, etc.). When connected, movement of the deployable cargo tray 1060 between the extended and retracted positions causes equivalent movement of the accessory 1040 with respect to the accessory carrier 104. Thus, movement of the deployable cargo tray 1060 from the extended position to the retracted position while connected to the accessory 1040 causes the accessory 1040 to be moved onto the extendable support 108, as shown in FIG. 10D. The closure 106 may then be moved to the use position, as shown in FIG. 10E, thereby securing the accessory 1040 with respect to the accessory carrier 104. Thus, movement of the accessory 1040 by the deployable cargo tray 1060 can assist in loading and unloading of the accessory 1040 with respect to the accessory carrier 104. In addition, movement of the accessory 1040 by the deployable cargo tray 1060 can allow access to items that are stored on the deployable cargo tray 1060, by temporarily moving the accessory 1040 using the deployable cargo tray 1060 to allow access to the items.

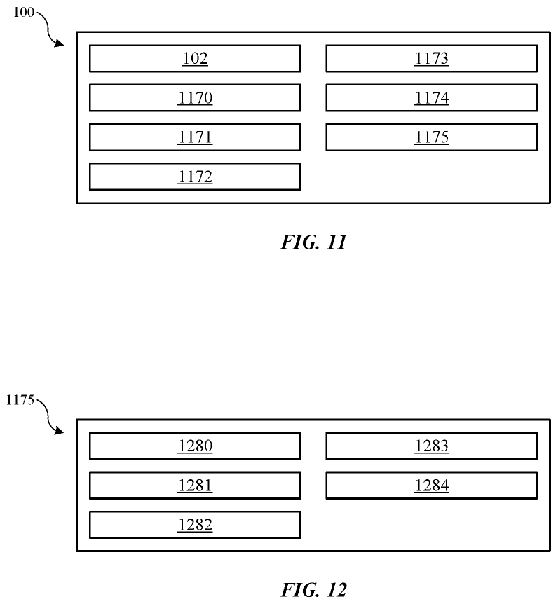

FIG. 11 is a block diagram that shows the vehicle 100. As an example, the vehicle 100 may be a conventional road-going vehicle that is supported by wheels and tires (e.g., four wheels and tires). As an example, the vehicle 100 may be a passenger vehicle that includes a passenger compartment that is configured to carry one or more passengers.

In the illustrated implementation, the vehicle 100 includes the vehicle body 102, a suspension system 1170, a propulsion system 1171, a braking system 1172, a steering system 1173, a sensing system 1174, and a control system 1175. These are examples of vehicle systems that are included in the vehicle 100. Other systems can be included in the vehicle 100.

The suspension system 1170 controls vertical motion of the wheels of the vehicle 100 relative to the vehicle body 102, and may include passive suspension components and/or active suspension components. The propulsion system 1171 includes propulsion components that are configured to cause motion of the vehicle 100 (e.g., accelerating the vehicle 100), such as an internal combustion engine, one or more electric motors, a battery, an inverter, one or more gearboxes, etc. The braking system 1172 provides deceleration torque for decelerating the vehicle 100. The steering system 1173 is operable to cause the vehicle 100 to turn by changing a steering angle of one or more wheels of the vehicle 100.

The sensing system 1174 includes sensors for observing external conditions of the environment around the vehicle 100 (e.g., location of the roadway and other objects) and conditions of the vehicle 100 (e.g., acceleration and conditions of the various systems and their components). The sensing system 1174 may include sensors of various types, including dedicated sensors and/or components of the various systems. The sensing system 1174 may include the sensors 107.

The control system 1175 includes communication components (i.e., for receiving sensor signals and sending control signals) and processing components (i.e., for processing the sensor signals and determining control operations), such as a controller. The control system 1175 may be a single system or multiple related systems. For example, the control system 1175 may be a distributed system including components that are included in other systems of the vehicle 100.

The control system 1175 may include autonomous driving functions that are configured to control operation of vehicle actuator systems of the vehicle 100 without manual control inputs. As an example, the control system 1175 may use inputs received from sensors, such as the sensors 107, to understand the environment around the vehicle 100 and may determine commands that are sent to one or more vehicle actuator systems, such as the propulsion system 1171, the braking system 1172, and the steering system 1173, to cause the vehicle 100 to travel from a current location toward a destination location.

The autonomous driving functions that are implemented by the control system 1175 can be used to cause the vehicle 100 to pick up and deliver items autonomously using the cargo carriers described herein, such as the accessory carrier 104. Initially, the vehicle 100 may have the accessory carrier 104 in the closed position. At this time, the vehicle 100 is not carrying an accessory, such as the accessory 340. The vehicle 100 may receive a command that instructs the vehicle 100 to pick up an item at a specified pick up location and transport the item to the specified drop off location. This command may be received and processed by the control system 1175 of the vehicle 100. In response to the command, the vehicle 100 drives autonomously from its current location to the specified pick up location. As an example, the vehicle 100 may drive autonomously to the specified pick up location without a human driver or passenger present in the vehicle 100.

Upon arriving at the specified pick up location, the vehicle 100 may position itself at a designated loading area. The designated loading area may be a predefined location, for example, specified by geospatial coordinates or by indicators (e.g., painted lines) that are present at the predefined location. Upon arriving at the predefined location, the vehicle 100 automatically moves the accessory carrier 104 from the closed position to the loading position. A cargo item, such as the accessory 340, is then loaded onto the accessory carrier 104, either manually by persons present at the specified pick up location or by an automated system that is present at the specified pick up location, so that the accessory 340 is placed on the accessory support area 105. In this example, the accessory 340 may be a cargo storage container that has cargo items located inside of it. The accessory 340 may be secured to the accessory carrier 104, for example, using the releasable couplers 342. In one implementation, the releasable couplers 342 are actuated devices and are automatically engaged (e.g., by a command from the control system 1175) to secure the accessory 340 after it has been placed on the accessory support area 105 of the accessory carrier 104. After the accessory 340 is secured within the accessory support area 105 of the accessory carrier 104, the accessory carrier 104 may be moved from the loading position to the use position. The vehicle 100 may then drive autonomously from the specified pickup location to the specified drop off location.

Upon arriving at the specified drop off location, the vehicle 100 may move the accessory carrier 104 from the use position to the loading position and release securement of the releasable couplers 342 in order to allow the accessory 340 to be unloaded from the accessory carrier 104, either by persons located at the specified drop off location or by an automated system it is located at the specified drop off location. In another implementation, items may be unloaded from inside the accessory 340 after it arrives at the specified drop off location, and the vehicle 100 may optionally return to the specified pickup location to return the accessory 340, which is unloaded upon return, by the vehicle 100, at the specified pickup location.

Automated pickup and delivery of the accessory 340 or other items may occur while the vehicle 100 is being used to transport rideshare passengers who are not authorized to access the accessory 340. In such a case, the accessory 340 may be secured so that it cannot be accessed by persons who are being transported by the vehicle 100.

FIG. 12 is a block diagram that shows an example implementation of the control system 1175 and/or other computer-implemented systems of the vehicle 100. The control system 1175 may be a conventional computing device that includes include a processor 1280, a memory 1281, a storage device 1282, one or more input devices 1283, and one or more output devices 1284. The control system 1175 may include a bus or a similar device to interconnect the components for communication. The control system 1175 may include computer program instructions (e.g., stored on the storage device 1282) that are configured to cause the control system 1175 to perform the computer-implemented functions described herein with respect to the vehicle 100 and the accessory carrier 104.

The processor 1280 is operable to execute computer program instructions and perform operations described by the computer program instructions. As an example, the processor 1280 may be a conventional device such as a central processing unit. The memory 1281 may be a volatile, high-speed, short-term information storage device such as a random-access memory module. The storage device 1282 may be a non-volatile information storage device such as a hard drive or a solid-state drive. The input devices 1283 may include any type of human-machine interface such as buttons, switches, a keyboard, a mouse, a touchscreen input device, a gestural input device, or an audio input device. The output devices 1284 may include any type of device operable to provide an indication to a user regarding an operating state, such as a display screen or an audio output, or any other functional output or control.

As described above, one aspect of the present technology is the gathering and use of data available from various sources for use during operation of a vehicle. As an example, such data may identify the user and include user-specific settings or preferences. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, a user profile may be established that stores configuration related information that allows adjustment of operation of the vehicle according to user preferences. Accordingly, use of such personal information data enhances the user's experience.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of storing a user profile for adjusting systems according to user preferences, the present technology can be configured to allow users to select to “opt in” or “opt out” of participation in the collection of personal information data during registration for services or anytime thereafter. In another example, users can select not to provide data regarding usage of specific applications. In yet another example, users can select to limit the length of time that application usage data is maintained or entirely prohibit the development of an application usage profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, configuration information may be determined each time the vehicle is used, such as by prompting the user to supply the information, and without subsequently storing the information or associating with the particular user.

What is claimed is:

1. A vehicle, comprising:
a vehicle body that defines an opening;
an extendable support movable between a retracted position and an extended position; and
a closure connected to the extendable support and movable between a closed position and a use position, wherein:
the closure is located in the opening of the vehicle body when the closure is in the closed position,
the extendable support is in the retracted position when the closure is in the closed position,
the closure is spaced from the opening of the vehicle body when the closure is in the use position,
the extendable support is in the extended position when the closure is in the use position, and
an accessory support area is defined between the closure and the vehicle body when the closure is in the use position, and the accessory support area is configured to allow connection of an accessory to the vehicle.

2. The vehicle of claim 1, further comprising:
a seal connected to the vehicle body and extending around the opening, wherein the seal is engaged with the closure when the closure is in the closed position, and the seal is engaged with the accessory when the closure is in the use position and the accessory is connected to the vehicle.

3. The vehicle of claim 1, further comprising:
releasable couplers configured to connect the accessory to at least one of the extendable support, the closure, or the vehicle body.

4. The vehicle of claim 1, wherein the accessory is located in an interior space of the vehicle body when the closure is in the closed position and the accessory is slidable at least partially out of the interior space of the vehicle body through the opening of the vehicle body when the closure is in the use position.

5. The vehicle of claim 4, further comprising:
a seal connected to the vehicle body and extending around the opening, wherein the seal is engageable with a peripheral surface of the accessory.

6. The vehicle of claim 1, further comprising:
a deployable ramp connected to the extendable support and movable between a stowed position and a deployed position.

7. The vehicle of claim 1, further comprising:
a pivot joint that connects the closure to the extendable support and is configured to allow the closure to pivot with respect to the extendable support between a generally upright orientation and a generally horizontal orientation.

8. The vehicle of claim 7, wherein the closure is in the generally upright orientation in the closed position and the closure is in the generally upright orientation in the use position.

9. The vehicle of claim 7, wherein:
the closure is movable to an open position,
the extendable support is in the retracted position when the closure is in the open position, and
the closure is in the generally horizontal orientation in the open position.

10. The vehicle of claim 7, wherein:
the closure is movable to a loading position,
the extendable support is in the extended position when the closure is in the loading position, and
the closure is in the generally horizontal orientation in the loading position.

11. The vehicle of claim 1, further comprising:
a sensor located on the closure and is configured to move with the closure.

12. The vehicle of claim 11, wherein the sensor is a camera.

13. A vehicle, comprising:
a vehicle body that defines an opening and a surface extending around the opening;
a seal located on the surface and extending around the opening;
an accessory carrier having an extendable support and a closure, wherein the accessory carrier is movable between a closed position and a use position by extension and retraction of the extendable support, and the closure is engaged with the seal in the closed position; and
an accessory connectable to the accessory carrier, wherein the accessory is in engagement with the seal when the accessory is connected to the accessory carrier.

14. The vehicle of claim 13, wherein engagement of the seal with the accessory seals an internal space of the vehicle against entry of water when the accessory is connected to the accessory carrier.

15. The vehicle of claim 14, wherein a longitudinal end wall of the accessory is oriented toward the opening and is in engagement with the seal when the accessory is connected to the accessory carrier.

16. The vehicle of claim 15, wherein the longitudinal end wall of the accessory is free from openings and an interior space of the accessory is not accessible from an interior space of the vehicle body when the accessory is connected to the accessory carrier.

17. A vehicle, comprising:
a vehicle body that defines an opening;
an extendable support movable between a retracted position and an extended position; and
a closure having an outer closure panel that is connected to the extendable support and an inner closure panel that is pivotally connected to the vehicle body, wherein:
the outer closure panel is movable between a closed position of the outer closure panel, in which the outer closure panel is adjacent to the inner closure panel and the extendable support is in the retracted position, and a use position of the outer closure panel, in which the outer closure panel is spaced from the inner closure panel and the extendable support is in the extended position to define an accessory support area, and
the inner closure panel is movable between a closed position of the inner closure panel, in which the inner closure panel is located in the opening, and an open position of the inner closure panel, in which the inner closure panel is spaced from the opening.

18. The vehicle of claim 17, further comprising:
a pivot joint that connects the outer closure panel to the extendable support and is configured to allow the outer closure panel to pivot with respect to the extendable support between a generally upright orientation and a generally horizontal orientation, wherein the outer closure panel is in the generally upright orientation in the closed position and the outer closure panel is in the generally upright orientation in the use position.

19. The vehicle of claim 18, wherein:
the outer closure panel is movable to an open position,
the extendable support is in the retracted position in the open position of the outer closure panel,
the outer closure panel is in the generally horizontal orientation in the open position of the outer closure panel,
the outer closure panel is movable to a loading position,
the extendable support is in the extended position in the loading position of the outer closure panel, and
the outer closure panel is in the generally horizontal orientation in the loading position of the outer closure panel.

20. The vehicle of claim 17, further comprising:
releasable couplers configured to connect an accessory to at least one of the extendable support, the outer closure panel, the inner closure panel, or the vehicle body in order to secure the accessory.
